(19) United States
(12) Patent Application Publication
(10) Pub. No.: US 2009/0319335 A1
(43) Pub. Date: Dec. 24, 2009

(54) NASCAR CAR CARE AUTO FAIR

(76) Inventors: Mark M. Gates, St. Paul, MN (US); David M. Hynes, Charlotte, NC (US)

Correspondence Address: 3M INNOVATIVE PROPERTIES COMPANY, PO BOX 33427, ST. PAUL, MN, 55133-3427, US

(21) Appl. No.: 12/374,077

(22) PCT Filed: Aug. 17, 2007
(86) PCT No.: PCT/US07/76245

§ 371 Date: Jan. 16, 2009

Related U.S. Application Data
(60) Provisional application No. 60/822,848, filed on Aug. 18, 2006.

(51) Int. Cl. G06Q 30/00; G06Q 90/00; G06Q 10/00; G06F 17/30

(52) U.S. Cl. 705/10; 705/500; 705/1; 705/14.5; 707/104.1; 707/3; 707/E17.044; 707/E17.108; 707/E17.005; 707/200

(57) ABSTRACT

The present disclosure is related to the combination of a car show and product demonstration in connection with a NASCAR race. Car enthusiasts may be invited to participate and bring their cars for display at the car show. While at the show, the car enthusiasts may be exposed to several displays promoting and demonstrating products targeted to the car care enthusiasts. Sales data or survey data may be collected at the car show to enable data mining to determine associations between various products featured at the car show and attendees of the car show. A car care product company may easily market products to attendees of the NASCAR race. The company may also demonstrate the quality of the products by showing the use of the products in a real-world environment, such as with the NASCAR automobiles or with cars of the car enthusiasts participating in the car show.

This application claims the benefit of U.S. Provisional Application No. 60/822,848, filed Aug. 18, 2006, the entire contents of which are incorporated herein by reference.

### TECHNICAL FIELD

The invention relates to automotive products.

### BACKGROUND

Car enthusiasts may be described as individuals who own and drive their own show cars, which may be vintage or restored cars such as '57 Chevy's, Corvettes, hot rods, or kit cars. Car enthusiasts may also have interest in newer model sport or luxury cars. Car enthusiasts may work on repairing or restoring their cars, and accordingly, many auto body shop owners are also car enthusiasts. Car enthusiasts are an elite group of individuals not easily reachable by traditional marketing methods.

### SUMMARY

In general, the present disclosure is related to the combination of a car show and product demonstration in connection with a NASCAR race. NASCAR (the National Association for Stock Car Auto Racing) is the largest sanctioning body of motorists in the United States. NASCAR sanctions over 1500 races at over 100 tracks in 38 states, Canada, Mexico, and other foreign countries. The three largest racing series sanctioned by NASCAR are the NEXTEL Cup, the Busch Series, and the Craftsman Truck Series.

Car enthusiasts may be invited to participate, for example, by bringing their own cars for display at the car show. Additionally, new cars or other cars not owned by enthusiasts may be featured such as, for example, concept cars. While at the show, the car enthusiasts are exposed to several displays promoting and demonstrating products targeted to the car care enthusiast. Such an event is referred to herein as a “Car Care Auto Fair.”

In one embodiment, the invention is directed to a method comprising identifying a venue for a National Association for Stock Car Auto Racing (NASCAR) race, determining a portion of the venue for a car care auto fair, holding the car care auto fair at the determined portion of the venue in close proximity in time to the NASCAR race, and demonstrating a use and benefits of an automotive product featured at the Car Care Auto Fair.

In another embodiment, the invention is directed to a system comprising a server having a database to store data collected from a sale of a product at a car care auto fair held in close proximity to a NASCAR race. The system also includes a computing device to receive the data from the sale of the product and to transmit the data to the database. Moreover, the system includes a network to enable communication between the server, the database, and the computing device.

The techniques described herein may provide several advantages. For example, a car care product company may easily market products to attendees of a NASCAR race. The company may also demonstrate the quality of the products by showing the use of the products in a real-world environment, such as with the NASCAR automobiles or with cars of the car enthusiasts participating in the car show. Moreover, the company may use data mining to determine relationships between various products and attendees of the Car Care Auto Fair or the NASCAR race. The company may further determine relationships between various demographic groups and particular products featured at the Car Care Auto Fair.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a pictorial illustration of an example exhibition of a Car Care Auto Fair held in conjunction with and close proximity to a NASCAR event.

FIG. 2 is a pictorial illustration of an example demonstration area in further detail.

FIG. 3 is a pictorial illustration of an example product demonstration booth in greater detail.

FIG. 4 is a flow chart illustrating an example mode of operation of a Car Care Auto Fair.

FIG. 5 is a flow chart illustrating an example method for dynamically updating a display of products featured at a Car Care Auto Fair.

FIG. 6 is a block diagram illustrating an example embodiment of a computer system for performing automated data mining and real-time update of electronic marketing information displayed within the Car Care Auto Fair.

### DETAILED DESCRIPTION

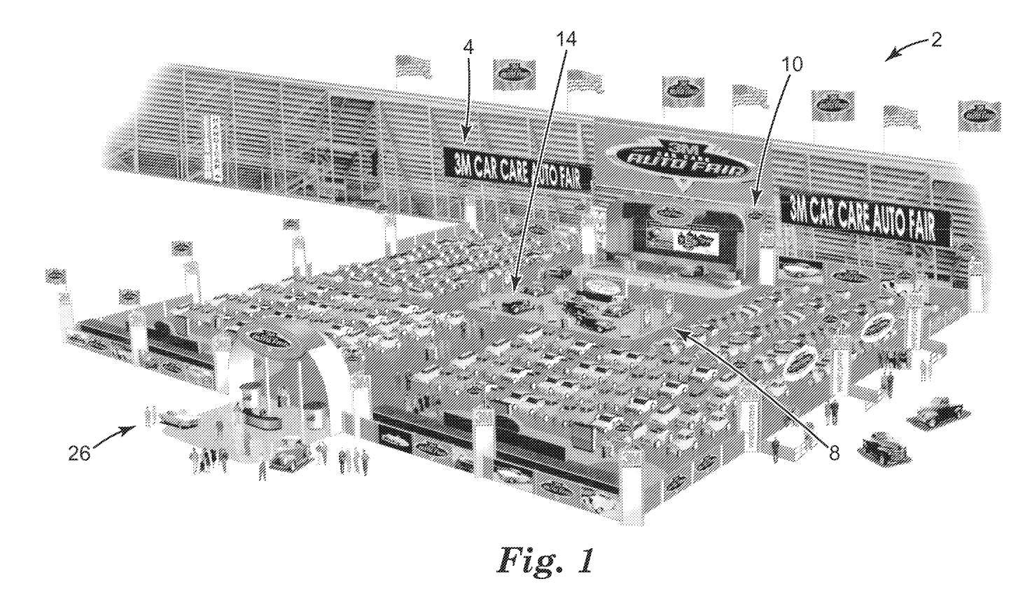

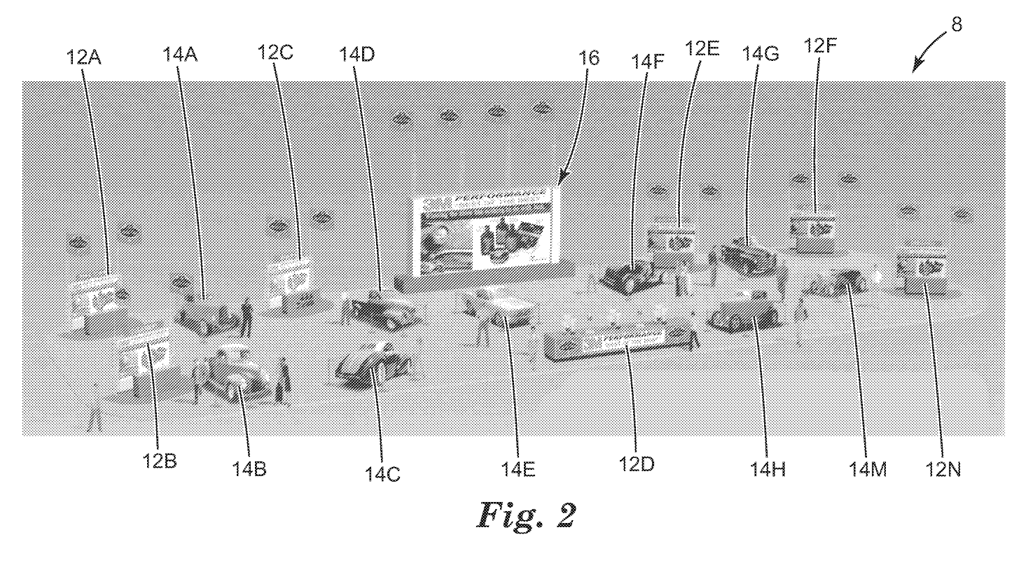

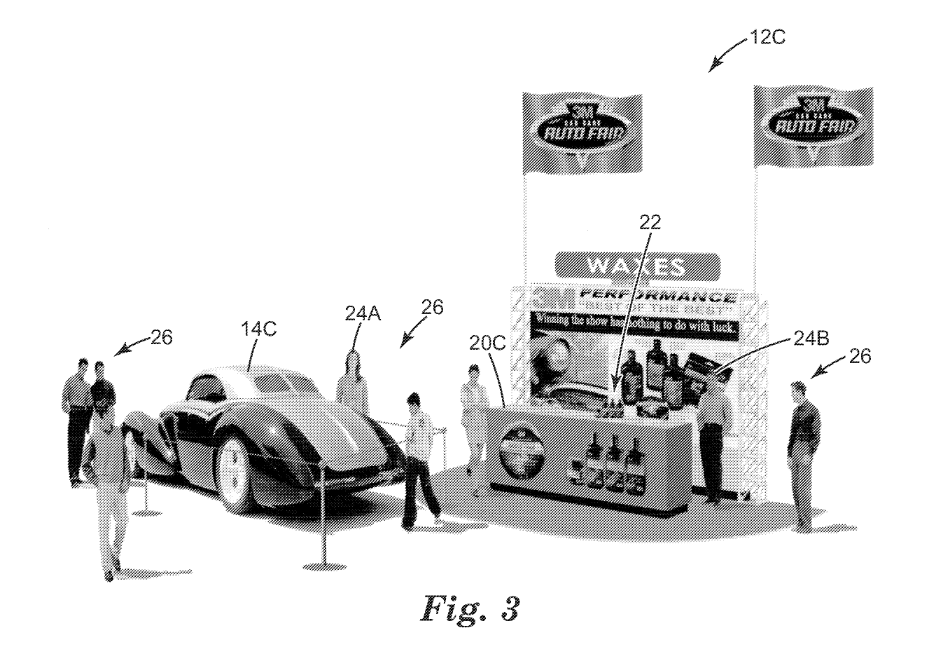

The present disclosure is related to the combination of a car show, such as a Car Care Auto Fair 2 (FIG. 1) and product demonstration in connection with a NASCAR race. In close proximity to a NASCAR racing event, a car show would be held featuring cars which may range from new cars to vintage/restored cars or kit cars. For example, the Car Care Auto Fair may be held concurrently with the NASCAR racing event or before and/or after the NASCAR racing event. Moreover, once a venue for the NASCAR racing event has been determined, a portion of the venue may be allocated for the Car Care Auto Fair. In one example, car enthusiasts who are also body shop owners would be invited to bring their project cars for display at the car show. In close proximity to the car show, several product display booths, e.g. booths 12 (FIG. 2), would be set up, featuring various car care products 22 (FIG. 3) and product demonstrations. Products 22 displayed and demonstrated at the Car Care Auto Fair 2 may or may not be for sale. In addition, products 22 may be given away along with other offers or promotional items.

FIG. 1 is an illustration of an example exhibition of a Car Care Auto Fair 2 attended by attendees 26. The Car Care Auto Fair 2 may display products 22 such as: 1) collision repair products, such as abrasives, coatings, sealers, polishing compounds, and masking products; 2) paint preparation products, such as the Paint Preparation System (PPS) manufactured by the 3M Company; 3) mechanical products such as intake system and injection cleaners, mechanical aerosols, gasket sealers, adhesives, and lubricants; 4) glass Installation products such as adhesives, abrasives, and sealers; and 5) vehicle appearance products such as cleaners, degreasers, polishers, and interior treatments.

The example exhibition of Car Care Auto Fair 2 of FIG. 1 includes advertisements 4, demonstration area 8, and a main stage 10. Advertisements 4 may advertise the existence of Car Care Auto Fair 2 to NASCAR race attendees to encourage attendance at Car Care Auto Fair 2. In one embodiment, NASCAR race attendees may be offered a discount to attend Car Care Auto Fair 2 or may attend for free. For example, NASCAR race attendees may prove race attendance at the Car Care Auto Fair by producing a ticket stub, thereby gaining admission to Car Care Auto Fair 2 for free or at a discounted rate. In another embodiment, Car Care Auto Fair attendees 26 may be offered NASCAR tickets at a discounted rate. In yet another embodiment, tickets to both a NASCAR race and a Car Care Auto Fair 2 may be offered as a package, whereby a purchaser of the package would receive the tickets to each event at a discount compared to buying the tickets individually. In still another embodiment, attendance at the Car Care Auto Fair 2 may be free for anyone, but NASCAR race participants may receive a discount off of products 22 sold at Car Care Auto Fair 2, as opposed to general public admission.

The product demonstrations may be carried out on actual cars 14 at Car Care Auto Fair 2. In addition to the demonstrations and to further enhance the appeal of the event, Car Care Auto Fair 2 may include a stage area featuring a host, musical entertainment, celebrity guests such as race car drivers and/or pit crews, participant interviews, and other opportunities for participant interaction. Moreover, a pit crew for one of the drivers of the NASCAR race may patrol the Car Care Auto Fair 2 to describe the various products the pit crew uses on actual race cars and why they choose those particular products. The pit crew may also give advice on automobile care or participate in product demonstrations.

The Car Care Auto Fair 2 held in connection with a NASCAR race may provide a unique marketing opportunity to target car care enthusiasts. NASCAR enthusiasts tend to be more brand-loyal than any other sporting audience. Use of the techniques described herein, e.g. the Car Care Auto Fair 2, may help in establishing a brand-name connection with NASCAR enthusiasts. Likewise, allowing car care enthusiasts to see live product demonstrations may further enhance the marketing opportunity of connecting with the car care enthusiasts and NASCAR fans.

Organizers of Car Care Auto Fair 2 may use data related to NASCAR ticket sales to tailor Car Care Auto Fair 2 to the particular attendees of the NASCAR race. For example, the organizers may attempt to predict the necessary size and space allocated to Car Care Auto Fair 2 based on the geographic area of the venue and the number of tickets sold at the NASCAR race. Likewise, the organizers may use ticket sales to the NASCAR race or other information to tailor products 22 (FIG. 3) offered at Car Care Auto Fair 2. For example, if the NASCAR race is being held in a cold weather state where fuel-line freezing is a problem, the organizers could emphasize a product for preventing fuel-line freezing at Car Care Auto Fair 2. As another example, if the NASCAR race is being held in or near a rainy state, the organizers may emphasize products for resisting rain, such as special glass treatments, wiper blades, tire construction/design, internal glass fogging prevention, specially designed headlights, sealers, or other such products. Moreover, advertising 4 and other exhibits may be electronic in form and be selected in an automated or semi-automated fashion by a computer based on these or other factors.

The NASCAR race may be further connected to the Car Care Auto Fair 2 through the use of, for example, dynamic advertising. For example, the NASCAR venue may include an electronic billboard for displaying information such as the standings of the various drivers to NASCAR race attendees. Organizers of the Car Care Auto Fair 2 may utilize the electronic billboard to describe various features of Car Care Auto Fair 2, such as making the presence of the Car Care Auto Fair 2 known to NASCAR race attendees. In other embodiments, a plurality of electronic billboards may display the standings of the various drivers to NASCAR race attendees. The electronic billboards may also depict information, replays, and/or highlights of the race, such as when a driver overtakes the leader to become the new leader, various techniques used by various drivers, replaying and/or timing various drivers' pit stops, the currently displayed flag color, and/or demonstrating the cause of an accident.

Moreover, the organizers of the Car Care Auto Fair 2 may note particular products that various racers use on their actual race cars using the electronic billboard or billboards, and electronic marketing information may be delivered and updated in real-time within the Car Care Auto Fair 2 based on the current state of the race. For example, if a particular driver is leading the race, and the driver uses products being featured at Car Care Auto Fair 2, those products used by the leading driver could be advertised and connected to the driver. For example, if Greg Biffle is leading the NASCAR race, and the pit crew for Greg Biffle uses the Paint Preparation System (PPS) manufactured by the 3M Company to paint the #16 car driven by Greg Biffle, the electronic billboard could advertise the PPS in connection with Greg Biffle taking the lead. Likewise, if Greg Biffle pits, i.e. enters the pit area for a pit stop, the electronic billboard could advertise mechanical maintenance chemicals, such as those manufactured by the 3M Company, used in the #16 car driven by Greg Biffle. Moreover, if one of the race cars suffers minor damage during the race, the electronic billboard could advertise collision repair products, such as products from the Perfect-It™ III series of collision repair products manufactured by the 3M Company, assuming that none of the drivers is injured in the collision.

The organizers may further make decisions as to which products to stock for the Car Care Auto Fair 2 based on demographic information for attendees collected from, e.g., ticket sales for the NASCAR event. For example, a particular NASCAR race may be held in an area in which attendees of NASCAR races are particularly interested in custom paint jobs for their automobiles. In this case, the organizers may determine that the Car Care Auto Fair 2 should emphasize products associated with customized paint jobs. The organizers may also decide that a particular booth should be established for giving live painting demonstrations to attendees of Car Care Auto Fair 2 for this venue.

As another example, the organizers may determine that products that enhance fuel efficiency should be emphasized at a particularly lengthy race track, such as the Talladega Superspeedway. Talladega is the longest race track in the NASCAR NEXTEL Cup schedule at 2.66 miles. Accordingly, the organizers may wish to emphasize products for enhancing fuel efficiency at such a venue.

As yet another example, a Car Care Auto Fair 2 held in connection with the Michigan International Speedway (MIS) may, for example, particularly emphasize products tailored to combat the effects of winter and road salt on vehicles. Some parts of Michigan receive 100 to even 150 inches of snowfall on average per year. Organizers of the MIS Car Care Auto Fair 2 may determine that emphasizing products such as abrasives for removing rust from vehicles caused by salt and other road treatment chemicals would be particularly well received by attendees of NASCAR races at MIS. The organizers may also determine that the MIS attendees may receive particular cleaning products suited for removing such salt and chemicals from the body of the car to prevent rust damage from occurring.

FIG. 2 is an illustration of an example demonstration area 8 in further detail. Demonstration area 8 includes various product demonstration booths 12A-12N (“booths 12”). Cars 14A-14M (“cars 14”) may be associated with respective booths 12. For example, car 14A may be associated with booth 12A. In other embodiments, each of booths 12 may have zero, one, or more associated cars. For example, car 12A is associated with booth 12A in the example of FIG. 2, while booth 12D has two associated cars 14E and 14F. Likewise, some cars may stand alone without being associated with any one of booths 12, such as car 14D of FIG. 2. Attendees of Car Care Auto Fair 2 may peruse booths 12 to see live product demonstrations, view electronic product information and advertisements, obtain information from demonstrators 24, receive advice from other attendees 26, attempt use of products 22, purchase one or more of products 22, receive trial size or full size versions of products 22, or for other reasons.

Car Care Auto Fair 2 may include multiple demonstration areas 8. Signs, such as sign 16 of FIG. 2, may be used to indicate locations of various categories of products. For example, demonstration areas 8 may be categorized into collision repair, mechanical maintenance/repair, glass installation, vehicle appearance, or other categories. Sign 16 of FIG. 2 may indicate that the associated demonstration area includes performance-enhancing products. A category may further include sub-categories. For example, the vehicle appearance demonstration area may include various booths 12 for tire care, cleaners, waxes, internal detailing, or other vehicle appearance enhancers.

A particular one of booths 12 may be designated to demonstrate products 22 that are not yet available for purchase. For example, the latest product innovations may be described and/or demonstrated. Such booths could provide information of what the product(s) are for, how they are used, and an anticipated release date. This may provide the advantage of letting attendees 26 know what to look for in the near future and when such innovative products will be available. Likewise, this may keep attendees 26 interested in future NASCAR races and Car Care Auto Fairs.

FIG. 3 is an example illustration of a product demonstration booth 12 in greater detail. The example of FIG. 3 is an enhanced illustration of booth 12C of FIG. 2. Exemplary booth 12C includes associated car 14C, sign 18C, product table 20C, products 22, demonstrators 24A-24B (“demonstrators 24”), and attendees 26. Although the example of FIG. 3 includes two demonstrators 24 associated with booth 12C, any number of demonstrators 24 (i.e., zero or more) may be associated with booth 12C. Moreover, some demonstrators 24 may participate in several of booths 12. For example, demonstrator 24B may participate in each of booths 12A, 12B, and 12C.

In an example operation, attendees 26 may browse booth 12C to view car 14C as well as to learn about products 22. Demonstrators, such as demonstrator 24A, may demonstrate intended use of products 22 by using one or more of products 22 on car 14C. Demonstrator 24B may perform demonstrations and may also perform sales of products and/or product give-aways. For example, Car Care Auto Fair 2 may include prize drawings such as raffles to give away either trial- or full-size versions of one or more of products 22. Booths such as booth 12C may also include trial-size versions of products 22 to freely give to attendees 26 for personal trials. Demonstrators 24 may also describe the benefits of products 22 to attendees 26.

Likewise, demonstrators 24 may provide side-by-side comparisons of products 22 over competitive products (not shown). For example, one of demonstrators 24 may apply one of products 22, such as car wax, to car 14C, while the other of demonstrators 24 applies a competitive car wax to a different portion of car 14C. Thus attendees 26 may personally witness the difference between products 22 over the competition. Such demonstrations may also be blind demonstrations, for example, by withholding information of which demonstrator 24 is applying which version of the product, asking attendees 26 which version is better, and then revealing the identity of the better-performing product.

Demonstrators 24 may further provide insights and information to attendees 26 based on the knowledge and experience of demonstrators 24. Preferentially, demonstrators 24 may be knowledgeable of car repair, restoration, and maintenance, as well as the products 22 offered at booths 12. Thus, if a particular attendee asks a question of a demonstrator, such as demonstrator 24A, demonstrator 24A may answer the question and recommend a product at the local booth, i.e. booth 12C, or may direct the attendee to a different one of booths 12 for an appropriate product recommendation of products 22. The organizers of Car Care Auto Fair 2 may also provide training sessions for demonstrators 24 to provide information regarding products 22 and training on how to use products 22.

Demonstrators 24 may also feature certain ones of products 22 at particular booths 12. For example, the organizers of the Car Care Auto Fair 2 may attempt to determine market response to a new product by allowing demonstrators 24 to describe and demonstrate the use of the product. Demonstrators 24 may also collect survey information of attendees 26 with respect to the new product. The survey may determine, for example, how willing attendees 26 would be to try and/or purchase the new product and at what price. Likewise, demonstrators 24 may give away samples of the new product or full-size portions of the new product, potentially with a request that the recipients use the new product and rate the new product at a later date. Attendees 26 may rate the new product either with a paper form or online at, for example, the manufacturer's website.

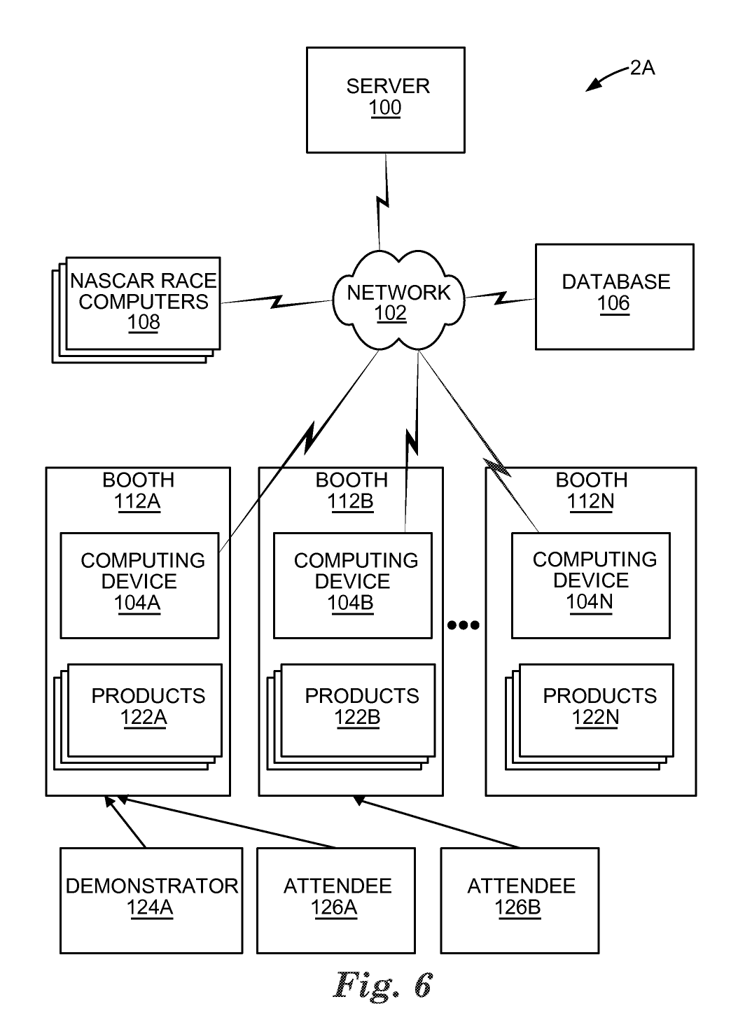

Moreover, organizers of the Car Care Auto Fair 2 may utilize a computer system to perform data mining on data collected from Car Care Auto Fair 2 and/or the NASCAR event. For example, the organizers may analyze the collected data to determine which groups were most receptive to new products in order to develop marketing strategies. The organizers may also attempt to determine ways in which to further develop certain products 22, such as new products. Data may be collected in various computing terminals during Car Care Auto Fair 2, such as sales data, survey data, catalog requests, product orders, or other data. Moreover, the computer system may operate so as to update electronic information with Car Care Auto Fair 2 in real-time. An example Car Care Auto Fair 2A designed for data mining and real-time processing is described in greater detail with respect to FIG. 6.

Other ones of booths 12 may include products 22 unrelated to racing but suited to the needs of attendees 26. For example, one or more of booths 12 may include home improvement products, home maintenance products, office products, safety products such as safety products for industrial environments, or other products. Thus one or more sponsors of Car Care Auto Fair 2 may advertise more products that may further enhance brand loyalty among attendees 26. Organizers of Car Care Auto Fair 2 may determine which other categories of products should be made available based on, for example, demographics such as age, gender, income, socio-economic status, background, product needs, level of interest in automobiles, or other information of attendees 26.

Booths 12 may include a variety of products. For example, one of booths 12 may include a set of various abrasive products used in surface preparation for painting and repairs. Such products include, for example, abrasives for finish sanding, smoothing, rust removal, or a variety of car care tasks. Organizers of Car Care Auto Fair 2 may specifically advertise such products in markets where the organizers determine that such products are necessary. For example, the organizers may determine that NASCAR race fans of a particular venue particularly enjoy customized paint jobs. The organizers may also determine that car enthusiasts have particular challenges associated with rust due to, for example, use of salt or other chemicals to melt ice and snow during winter months. Accordingly, the organizers may emphasize abrasive products designed to remove rust damage in such markets.

One of booths 12 may also include various adhesive products. Automotive enthusiasts use adhesives for a wide range of purposes. For example, certain adhesives are used to apply plastic emblems to the body of an automobile. Plastic adhesives are also used to bond rigid plastic parts and taillight lenses to the automobile. Other adhesives may be used to secure a rearview mirror to the front windshield. Organizers of Car Care Auto Fair 2 may determine that a particular market is suited for special adhesives for decorating automobiles, either internally or externally, through the use of adhesives to apply ornamental objects to the automobile.

As another example, one of booths 12 may include various masking products. Masking tape, for example, may be used during painting to paint crisp, straight lines on the surface of an automobile. Masking products may also take other forms, such as papers and liquids. Moreover, one of booths 12 may include the Paint Preparation System (PPS) manufactured by 3M Company. The booth including the PPS may be the same booth as that displaying the various masking products. The PPS is a closed paint system which eliminates the need for separate mixing cups and filters. Instead, paint is mixed in a liner bag which marries to a direct filter and is then mounted on the spray gun with a dedicated adapter. As freshly filtered paint is dispensed, the liner bag collapses, allowing the spray gun to function at any angle. A liner bag and a filter are disposable, leaving only the spray gun and adapter to be cleaned. The PPS is therefore a cleaner, faster system, safe from outside contamination and offering considerable time and solvent savings on gun and parts cleaning. Organizers of the Car Care Auto Fair 2 may determine a particular demand for items such as the PPS and offer and/or emphasize the presence of such products at the Car Care Auto Fair 2. For example, for products 22 that solve a particular problem, the organizers of Car Care Auto Fair 2 may ensure that demonstrations exist for solving the problem through the use and demonstration of certain products 22 such as the PPS.

Yet another of booths 12 may include products used in collision repair, e.g., polishes and buffs. For example, one of booths 12 may include products from the 3M Perfect-It™ III product line. Car Care Auto Fair 2 may advertise such products when a car receives minor damaged during the NASCAR race, and the exemplary computer system described below may operate so as to automatically display such products in conjunction with video clips showing the damage, provide no race personnel was harmed and the damage was minor. Similar techniques may be applied to update in real-time the electronic information displayed in Car Care Auto Fair 2 in the event of spillage of gasoline or other chemicals within the NASCAR event. In this way, attendees of the NASCAR race may be informed of what products are suitable for use for repairing visual and/or structural damage caused by automobile collisions and/or cleaning of accidental spillage. Demonstrators 24 may also request access to a damaged automobile from the NASCAR race to give a demonstration of the use of such products on a vehicle that has suffered actual collision damage.

Mechanical abrasives, used for cleaning and surface preparation of an automobile, may be featured at another one of booths 12. Certain mechanical abrasives may be used for cleaning, e.g. buffing, the body of the automobile. Other mechanical abrasives may be used for preparing the surface of the automobile for painting and/or restoration.

One of booths 12 may also feature various mechanical maintenance chemicals. These chemicals may include, for example, chemicals for cleaning the air intake and fuel injector, mechanical aerosols, gasket sealers, adhesives, lubricants, and abrasives. Organizers of Car Care Auto Fair 2 may make business decisions about how many of these products to stock based on geographic region, demographics of NASCAR race attendees gathered, e.g., by information obtained through ticket sales, time of the year, or other methods.

One or more of booths 12 may include various products used for cleaning air intake systems and fuel injectors. Such cleaners may be sold individually as separate items, or they may be sold in packages, e.g. a package including an air intake system cleaner and a fuel injector cleaner. Organizers of Car Care Auto Fair 2 may gather data from previous and current auto fairs to determine the best packaging structure to use for these and other products 22. For example, the organizers may gather and analyze sales data as to how many units of products were sold when the products were sold individually and to compare this data against how many products were sold when the products were sold in a package. Likewise, the organizers may determine which sales approach generates greater revenue or which sales approach reaches the most consumers, for example, by continuing to gather sales data once Car Care Auto Fair 2 has ended.

As still a further example, one of booths 12 may feature various glass installation products. Such products may include, for example, adhesives, abrasives, and/or sealers. Demonstrators 24 may organize a demonstration of these products by, for example, demonstrating the installation of glass in one of cars 14. Organizers of Car Care Auto Fair 2 may also determine that a particular venue is well suited for demonstrating and/or emphasizing sale of such glass installation products. For example, the organizers may determine that, due to a particularly severe and recent hail storm, many NASCAR race attendees may be looking for glass replacement. The organizers may then decide to emphasize glass installation products.

Another one of booths 12 may include vehicle appearance products. Such products may include, for example, cleaners, degreasers, polishes, and interior treatments. Organizers of Car Care Auto Fair 2 may decide to emphasize or include particular booths 12 for selling and/or demonstrating vehicle appearance products. Demonstrators 24 may, for example, use the cleaners to wash the cars of attendees 26. Likewise, demonstrators 24 may use the interior treatments to detail the interior of particular cars 14 as a demonstration or for a fee.

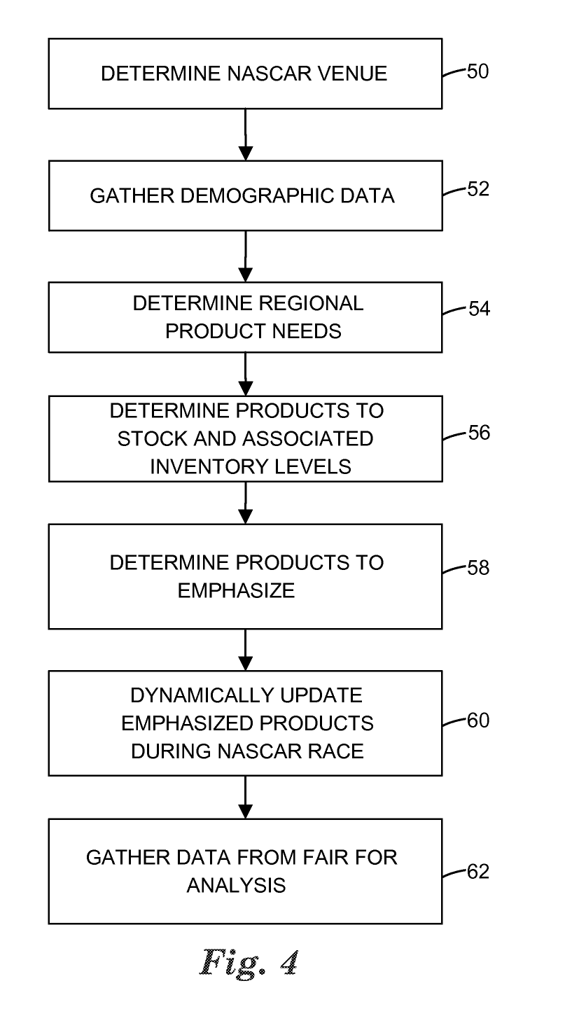

FIG. 4 is a flow chart illustrating an example mode of operation of Car Care Auto Fair 2. Initially, organizers of Car Care Auto Fair 2 may determine a venue for a NASCAR race (50). For example, the organizers may make an initial assessment as to the feasibility of holding Car Care Auto Fair 2 at various NASCAR tracks. The assessment may be based on, for example, seating capacity at the venue and whether an area large enough to hold the additional capacity for the Car Care Auto Fair 2 is available. Moreover, the organizers may determine a particular number of Car Care Auto Fairs 2 to be held in a particular racing season and may assess whether the particular venue is better or worse than other venues for holding a Car Care Auto Fair 2. Likewise, the organizers may need to negotiate with the venue owners to obtain acceptance to hold a Car Care Auto Fair 2.

Once organizers of the Car Care Auto Fair 2 have determined that a particular venue will host a Car Care Auto Fair 2, the organizers may gather demographic data for the market of attendees at the associated NASCAR race (52). For example, the organizers may use ticket sales as a barometer for determining the necessary size of the Car Care Auto Fair 2, the number of booths 12 to assemble, the number of demonstrators 24 to hire and/or invite, the number and composition of products 22 to store in inventory and to advertise, and other features of the Car Care Auto Fair 2. Likewise, the organizers may determine other factors of the target market, e.g. NASCAR race attendees, such as mean or median income, brand awareness, average age, particular needs or demand for products, or other information. For example, the organizers may gather demographic information from public databases regarding the race-going population of the area. The organizers may also attempt to determine who among the attendees of the NASCAR race are from the local area and who among the attendees has traveled to attend the NASCAR race.

The organizers may also determine product demand according to geographic location of the NASCAR race venue (54). The organizers may analyze this according to, for example, typical weather conditions, road conditions, driver attitudes, local customs with respect to automobiles, local automobile trends, existing marketing campaigns, or other information. The organizers may determine, for example, that certain venues are hosted in areas with particularly difficult winters, high rainfall, dry weather, sunny weather, or other particular climates that may affect the appearance and/or performance of automobiles.

The organizers may also determine technology-use levels of various regions. This information may be useful, for example, in determining whether the organizers may use various types of technology for reaching the target market. For example, organizers may determine that certain markets may be particularly well suited for receiving e-mail communications, text messages on cellular phones, telephone calls, Friendster and/or MySpace invitations, weblog subscriptions, electronic and/or hard-copy newsletters, catalogues, future demonstrations, or other types of communications. The organizers may also determine whether electronic communication during the Car Care Auto Fair 2 may be possible with Car Care Auto Fair attendees 26. For example, the organizers may send cellular telephone text messages to Car Care Auto Fair attendees 26 while attendees 26 are browsing various booths 12 to inform attendees 26 of various products 22 and/or special discounts on particular products 22.

Once market demands have been established, the organizers may then determine which products 22 to include at the Car Care Auto Fair 2 (56). Likewise, the organizers may determine associated levels of products 22 to stock for the Car Care Auto Fair 2. Organizers may determine that certain products 22 should be presented at the Car Care Auto Fair 2, but not stock any for sale and instead allow attendees 26 to place an order for a desired quantity. Likewise, if the estimates gathered at step (56) turn out to be inaccurate and certain products 22 are sold out, demonstrators 24 or other associated with Car Care Auto Fair 2 may collect orders for such sold out products. Collecting orders may be done on paper or electronically, e.g., through an online database.

The organizers may also determine whether particular products 22 should be emphasized at the Car Care Auto Fair 2 (58). For example, a brand new product or product line could be emphasized during the Car Care Auto Fair 2 to generate awareness of the product or product line, or to demonstrate the effectiveness and qualities of the new product or product line. This may generate excitement and anticipation about the new product. As another example, a product that is particularly suited to the market demand for the venue may also be emphasized. For instance, products for preventing and treating rust damage may be featured in areas with particularly difficult winters where large quantities of road treatments, such as salt or other chemicals, are used to remove ice and snow from roads. Emphasizing these products may further increase awareness of the products and attendees 26 may be particularly excited about such products.

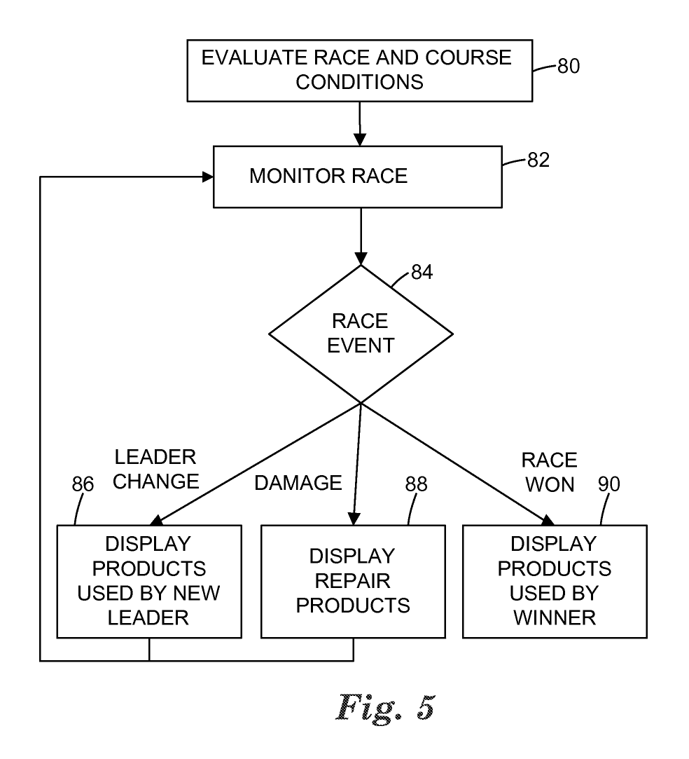

In some embodiments, the organizers of the Car Care Auto Fair 2 may obtain permission to use a device such as an electronic billboard to direct attention to the Car Care Auto Fair 2. For example, the electronic billboard may exist for displaying the current, real-time race standings to NASCAR race attendees. The organizers may use the electronic billboard to direct attention to the Car Care Auto Fair 2, as well as particular products 22 featured at the Car Care Auto Fair 2. Moreover, the organizers may dynamically adapt the display to the conditions and/or events of the race (60). Such dynamic updates are discussed in greater detail below with respect to FIG. 5.

Once the NASCAR race and/or Car Care Auto Fair 2 have ended, the organizers may gather data to evaluate the decisions that were made for future marketing efforts and/or future events (62). For example, the organizers may have decided to test the market response to a new product. The organizers may have featured the product at the Car Care Auto Fair 2 and directed attention to the product using an electronic billboard. Afterwards, the organizers may attempt to extrapolate demand for the product by how many of the products were sold, how many samples were given away, suggestions from attendees 26, survey results of attendees 26, or by other means. The organizers may then use this information to determine the production scale of products 22, marketing strategies, goals for a subsequent Car Care Auto Fair 2, or other information. Moreover, the organizers may perform data mining on the gathered data.

The organizers may enter gathered data into a computerized database to perform subsequent data mining. That is, the organizers may use computers or computerized-methods to extract various data or data trends to assist in organizing marketing campaigns and product development. The organizers may, for example, determine through the use of data mining that age demographics show that a younger audience is more interested in paint and decorative supplies, while an older audience is more interested in fuel efficiency. By obtaining such information, the organizers can help develop targeted marketing campaigns for maximizing revenue for a company and to ensure that various audiences are aware of the various products.

FIG. 5 is a flow chart illustrating an example method for dynamically updating a display of products featured at a Car Care Auto Fair 2. The process depicted in FIG. 5 is one example of the method of step (60) of FIG. 4. The organizers of Car Care Auto Fair 2 may first determine the race, weather, and/or course conditions of the particular venue (80) of a NASCAR race in an attempt to predict which products 22 should be emphasized. Certain race tracks may have reputations for various conditions due to, for example, geographic location, track construction, track rules, or other conditions.

For example, Talladega Superspeedway has rules regarding restrictor plates that prevent race cars from reaching top speed at Talladega. Because of this, race cars tend to be seen racing in very close proximity in tightly bunched groups. Therefore, one small error by one car or driver may case a massive multi-car accident known as “the Big One” among NASCAR drivers and enthusiasts. Accordingly, the organizers may prepare a Car Care Auto Fair 2 that particularly emphasizes products for repairing damage to automobiles, both structural as well as cosmetic, for a Car Care Auto Fair associated with a NASCAR race held at Talladega.

The organizers or an electronic system may monitor the NASCAR race (82). During the race, a race event may occur (84) that changes the emphasis of particular products, e.g. on an electronic billboard. Moreover, the products may be emphasized in conjunction with relevant video showing the event from NASCAR race. For example, the leader of the race may change, and in response, the electronic billboard may display what, if any, products at the Car Care Auto Fair are used by the new leader and his pit crew and/or advertised on the leader's car (86). In the event a car suffers minor damage without causing any injury, the emphasis may change to repair products (88), such as abrasives, windshield repair, painting systems, etc. Moreover, when the race ends, the emphasis may change to focus on what, if any, products at the Car Care Auto Fair 2 the winner of the race used in and/or advertised on his or her car. A fourth example includes the dynamic display of information related to cleaning spillage of gasoline or other substances within the NASCAR event. A fifth example includes the dynamic display of information related to fire prevention/protection. In other embodiments, an electronic billboard may display various products independently of the race conditions.

The example race events of FIG. 5 are intended as exemplary only and should not be construed as limiting. Other race events may occur that trigger a change in product emphasis. For example, if a rain storm develops, the organizers could operate an electronic billboard to emphasize products that are used for dealing with rain and associated conditions, such as internal window fogging.

FIG. 6 is a block diagram illustrating an example embodiment of a Car Care Auto Fair 2A equipped with a computer system to gather data in order to perform data mining and real-time processing. Car Care Auto Fair 2A is substantially similar to Car Care Auto Fair 2 of FIGS. 1-3, with the addition of computing devices 104A-104N (“computing devices 104”) at respective booths 112A-112N (“booths 112”), server 100, network 102, database 106, and NASCAR race computers 108. Server 100 may be on-site at Car Care Auto Fair 2A. Server 100 may also be off-site at a remote location and connected to network 102 through the Internet. Likewise, database 106 may either be on-site or off-site. It should also be understood that a plurality of demonstrators 124 and attendees 126 may be present at Car Care Auto Fair 2A, similar to the example embodiment of Car Care Auto Fair 2 shown in FIGS. 1-3.

Computing devices 104 may gather data from attendees of Car Care Auto Fair 2A, e.g. attendee 126A, or from demonstrators 124 of booths 12, e.g. demonstrator 124A. Demonstrator 124A may use computing device 104A as a visual aid or for reference while giving demonstrations to attendees, e.g. attendee 126A. Moreover, when an attendee, such as attendee 126A, purchases a product, such as one of products 122A, demonstrator 124A may enter sales data into computing device 104A, such as an item number, quantity sold, payment method, payment received, customer information such as name, address, telephone number, age, gender, or other information. Computing devices 104 may include a computer-readable medium comprising instructions for causing a programmable processor to execute the various functions of computing devices 104. The computer-readable medium may be a computer-readable storage medium, such as RAM, ROM, EEPROM, or other computer-readable media.

Demonstrator 124A may also gather survey information from attendee 126A such as how attendee 126A became interested in the product, how attendee 126A learned of Car Care Auto Fair 2A, the goals attendee 126A has for attending Car Care Auto Fair 2A, what attendee 126A likes about a particular one of products 122A, what attendee 126A would like to see improved about a particular one of products 122A, how long attendee 126A has been interested in NASCAR and/or automobiles generally, or other information.

Likewise, one or more of booths 112 need not necessarily have a demonstrator 124 to operate a corresponding one of computing devices 104. In the example of FIG. 6, booth 112B permits attendees, such as attendee 126B, to operate computing device 104B without a demonstrator. Computing device 104B may, for example, allow attendee 126B to view information about products 122B, to place an order for particular products, such as one of products 122B or any of products 122, to request a catalog, to view automobile care tips, to retrieve NASCAR statistics, to play NASCAR trivia games or games related to automobiles such as automobile care, to collect survey information, to view current NASCAR race standings, or to view or retrieve other information.

Computing devices 104 may be connected to network 102. The connection may either be wired or wireless. A wireless connection may be established, for example, according to the 802.11 a, b, or g protocols or a combination thereof. Communications to and through network 102 may be encrypted, for example, to prevent interception of private data from attendees 126. Server 100 may require authentication of each of computing devices 104 before permitting the computing device to connect to various resources, such as resources offered by server 100 and database 106. In one embodiment, server 100 may permit attendees 126 to connect to network 102 using a guest login ID and password. That is, server 100 may act as a wireless “hot spot” for attendees 126 of Car Care Auto Fair 2A such that the attendees 126 may wirelessly connect to the Internet.

Server 100 may control access to network 102. For example, server 100 may enforce various protocols, such as login requirements for computing devices 104. In addition, server 100 may direct content to and from computing devices 104. For example, server 100 may direct computing device 104A to gather customer information from attendee 126A, such as identifying information, demographic information, product information, and/or other information. Demonstrator 124A may enter this information into computing device 104A. Computing device 104A may then transmit the information through network 102, where database 106 may retrieve and store the information. In addition, database 106 may store data such as NASCAR statistics, race data, automobile care data such as car care tips, trivia data, information about one or more of products 122, Adobe® Flash™ animation data, JavaScript™ data, web page data, e.g. HTML or XML, or other data. Computing devices 104 may retrieve this data from database 106 through network 102 for displaying the data to attendees 126.

NASCAR race computers 108 may process and store race data and/or statistics on database 108 dynamically during a NASCAR race and may receive data from human entry and/or electronic sensors monitoring the race (e.g., RFID chips located within each race car used to sense current rank, fuel consumption, max speed, timing for pit changes, and the like). For example, the organizers of Car Care Auto Fair 2A, or other administrators associated with Car Care Auto Fair 2A, may enter data into NASCAR race computers 108 about the NASCAR race or such data may be collected automatically. One or more of NASCAR race computers 108 may be configured to automatically update the data. NASCAR race computers 108 may obtain data regarding, for example, the current standings of the NASCAR race, the current lap, total elapsed time of the race, fastest lap time, the holder of the fastest lap time, fastest pit time, the holder of the fastest pit time, number of laps remaining, the current flag color (e.g., green, yellow, red, etc.), who has held the lead position the longest, the most recent leader change, how long the current leader has held the lead position, current speed of one or more of the race cars, fastest achieved speed of one or more of the race cars, the name of the driver of the fastest achieved speed, or other information. This data may be saved in database 106. One or more of computing devices 104 may retrieve and display some or all of this data, possibly at the request of either a demonstrator 124 or an attendee 126.

Organizers of Car Care Auto Fair 2A, or others associated with Car Care Auto Fair 2A, may utilize the computer system of FIG. 6 to perform data mining on data collected from attendees 126 during Car Care Auto Fair 2A. The organizers may perform data mining either concurrently with or after Car Care Auto Fair 2A. The organizers may attempt to determine trends in product interest and/or product purchases associated with various attendees 126 or demographic categories of attendees 126. For example, through the use of data mining, the organizers may determine that younger members of attendees 126 are particularly interested in custom automobile paint supplies, while older members of attendees 126 are particularly interested in vehicle maintenance products. That is, the organizers may sift through the data stored in database 106 to determine trends in product interest associated with various groups of attendees 126. In this way, the organizers may be able to focus marketing campaigns on specific demographic groups. The organizers may also determine which of products 122 to develop further. The organizers may also determine interest levels of attendees 126 in new or recently developed products.

Computing devices 104 may include various user interfaces by which attendees 126 and/or demonstrators 124 may interact with computing devices 104. For example, one of computing devices 104 may include a traditional monitor, keyboard, and/or mouse. As another example, one of computing devices 104 may include a touch screen monitor. As a further example, one of computing devices 104 may only include a regular monitor for displaying information without including a means for obtaining input from users accessible by attendees 126 and/or demonstrators 124. One or more of computing devices 104 may further include speakers for delivering audio such as announcer commentary, aural information regarding one or more of products 122, text reading for the visually impaired, radio chatter between a driver and his/her crew, music, sound from a movie and/or product demonstration, or other audio data.

Various embodiments of the invention have been described. These and other embodiments are within the scope of the following claims.

1. A method comprising:
identifying a venue for a National Association for Stock Car Auto Racing (NASCAR) race;
determining a portion of the venue for a car care auto fair;
holding the car care auto fair at the determined portion of the venue in close proximity in time to the NASCAR race; and
demonstrating a use and benefits of an automotive product featured at the car care auto fair.

2. The method of claim 1, further comprising:
prior to the NASCAR race, determining an expected number of attendees to the NASCAR race; and
determining a size of the portion of the venue for the car care auto fair as a function of the number of the expected attendees for the NASCAR race.

3. The method of claim 1, further comprising:
obtaining data from attendees of the car care auto fair; and
performing data mining on the data to identify products of interest to the attendees.

4. The method of claim 3,
wherein obtaining data comprises obtaining data from the attendee regarding at least one of the attendee's age, gender, address, annual income, socioeconomic status, level of interest in automobiles, and product needs, and
wherein performing data mining comprises examining the data for associations between the demographic data and the products of interest.

5. The method of claim 3, further comprising:
obtaining sales data from sales of a product featured at the car care auto fair; and
using the sales data to further determine the associations between the demographic data for the attendees and the products of interest.

6. The method of claim 3,
wherein obtaining data comprises obtaining data with computing devices and storing the data in a database, and
wherein performing data mining comprises performing data mining with a computing device on the data stored in the database.

7. The method of claim 1, further comprising predicting a quantity for a product featured at the car care auto fair based on a predicted number of attendees to the NASCAR race held in proximity to the car care auto fair.

8. The method of claim 7, wherein the quantity describes how many of the product will be available at the car care auto fair based on a predicted level of sales of the product.

9. The method of claim 1, further comprising:
printing, for a car enthusiast, a ticket package of at least one ticket to the NASCAR race and at least one ticket to the car care auto fair; and
including in the ticket package an invitation to the car care auto fair, wherein the invitation includes a request to bring a car belonging to the car enthusiast.

10. The method of claim 9, wherein demonstrating comprises requesting that the car enthusiast demonstrate the use of the product on the car belonging to the car enthusiast.

11. The method of claim 1, wherein demonstrating comprises demonstrating the use and benefits of a product belonging to a product category of at least one of collision repair products, abrasives, coatings, sealers, polishing compounds, masking products, paint preparation products, mechanical products, intake systems, injection cleaners, mechanical aerosols, gasket sealers, adhesives, lubricants, glass installation products, vehicle appearance products, cleaners, degreasers, polishers, and interior treatments.

12. The method of claim 1, further comprising selecting and advertising automotive products at the car auto fair based on the products' use within the NASCAR race.

13. The method of claim 1, further comprising selecting and advertising an automotive product within the car care auto fair in response to an event that occurs within the NASCAR race.

14. The method of claim 13, wherein advertising comprising updating in real-time an electronic display within the car care auto fair to advertise the product in response to the event.

15. The method of claim 13, further comprising, when updating the electronic display in the car care auto fair, showing on the electronic display video of the event in the NASCAR race in conjunction with the produce selected in response to the event.

16. The method of claim 1, further comprising automatically updating in real-time electronic displays within the car care auto fair to advertise a product used by a driver in the NASCAR race or advertised on the driver's car when the driver takes the lead position.

17. The method of claim 1, further comprising automatically updating in real-time electronic displays within the car care auto fair to advertise a product for repairing a car when a car within the NASCAR race receives minor damage.

18. The method of claim 1, further comprising automatically updating in real-time electronic displays within the car care auto fair to advertise a product for cleaning spills of automotive substances when a spill of an automotive substance occurs within the NASCAR race.

19. The method of claim 1, further comprising:
prior to the NASCAR race, accessing ticket sale data for the NASCAR race with a computer to identify ticket purchasers,
obtaining demographic data for the ticket purchasers; and
selecting one or more products to feature at the car care auto fair in accordance with the demographic data for the ticket purchasers for the NASCAR race.

20. A system comprising:
a server having a database to store data collected from a sale of a product at a car care auto fair held in close proximity to a NASCAR race;
a computing device to receive the data from the sale of the product and to transmit the data to the database; and
a network to enable communication between the server, the database, and the computing device.

21. The system of claim 20, wherein the database is configured to store at least one of statistics for the NASCAR race, NASCAR trivia, automobile care data, product information for a product featured at the car care auto fair, or web page data.

22. The system of claim 21, wherein the computing device is configured to retrieve data from the database regarding at least one of product information for a product featured at the car care auto fair, statistics from the NASCAR race, NASCAR trivia, automobile care data, or web page data.

23. The system of claim 20, further comprising a NASCAR race computer to enter and update race data for the associated NASCAR race in the database.

24. The system of claim 20, wherein the database is configured to enable data mining on data stored in the database.

25. The system of claim 24, wherein the database is configured to permit organizers of the car care auto fair to execute at least one query to determine associations between at least one product type and at least one demographic of an attendee of the car care auto fair who purchased a product of the at least one product type.

26. The system of claim 20, further comprising:
at least one electronic display within the car care auto fair to present advertising information for one or more automotive products; and
a computer to select the automotive products and update the electronic display in real-time in response to events within the NASCAR race.
